(19) United States
(12) Patent Application Publication
(10) Pub. No.: US 2004/0124967 A1
(43) Pub. Date: Jul. 1, 2004

(54) Programmable electromechanical lock cylinder

(76) Inventor: Volker Lange, Hamburg (DE)

Correspondence Address: Craig C. Groseth, SHERIDAN ROSS P.C., Suite 1200, 1560 Broadway, Denver, CO, 80202-5141, US

(21) Appl. No.: 10/651,512

(22) Filed: Aug. 28, 2003

(30) Foreign Application Priority Data
Aug. 29, 2002 (DE) DE 101 07 756.4

(51) Int. Cl. G06F 7/04

(52) U.S. Cl. 340/5.64

(57) ABSTRACT

The invention relates to an electromechanical lock cylinder with integrated electronic control means which upon electronically detectable access rights creates and/or enables a rotating-connection between a lock catch which operates a lock bolt and manually or motor operated actuation means. According to the invention it is provided that the electronic control means of the cylinder lock comprise at least one wireless data signal transmission interface for transmitting data and in particular data for programming the access codes for the access rights.

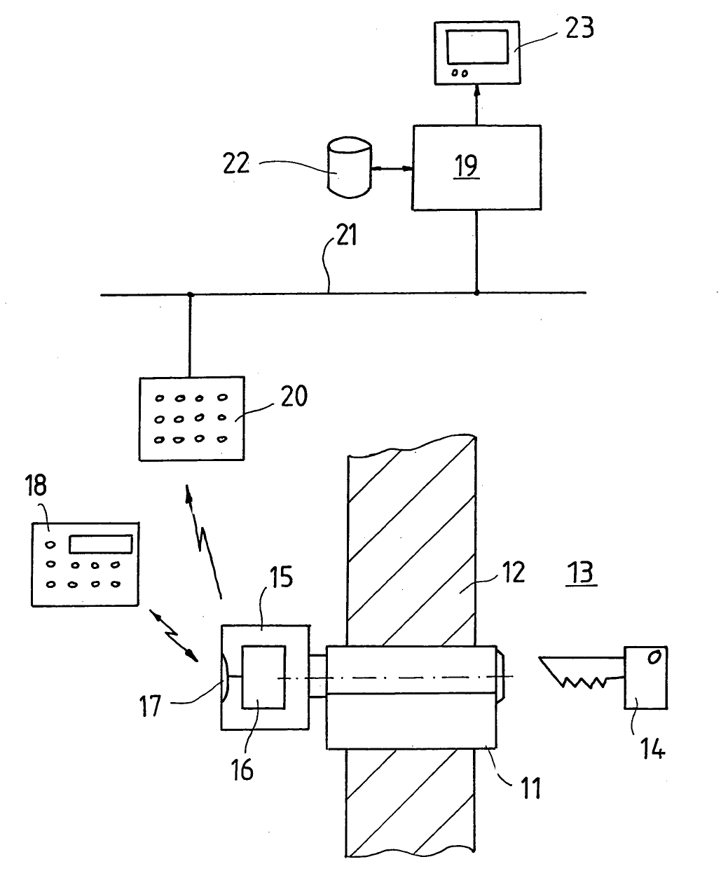

### DESCRIPTION

The invention involves an electromechanical lock cylinder with integrated electronic control means which upon electronically detectable access rights creates and/or enables a rotating-connection between a lock catch which operates a lock bolt and manually or motor operated actuation means.

Such electromechanical working lock cylinders are known e.g. from DE 199 30 054 A1. The lock cylinder has electronic control means located in a knob which control means interacts with the antenna of a transponder system. The passive counterpart to the transponder system is located on a key, which may be inserted in a conventional lock core with a mechanical locking mechanism. A rotating-connection between key and lock catch is created only if the key matches both mechanically and electronically. The electronic control means in the knob are programmable via an interface comprising a plug-type connector located underneath the knob cover. For programming, it is required to firstly disassemble the knob. This is very complicated in the case of a plurality of lock cylinders to be programmed.

Further it is known to use such electromechanical working lock cylinders in access control system networks. For instance, from EP 0 600 194 B1 it is known to connect the control and/or receiving electronic means in question with a central unit using a bus system. Here it is required to connect the lock cylinders to the bus system in question by a signal cable. This significantly complicates the installation for each lock cylinder.

It is an object of the invention to design an electromechanical lock cylinder as described above in such a way that it on the one hand enables easy programming. On the other hand, it should allow the unproblematic use of the lock in access control systems.

The object is solved by the invention in that the electronic control means of the cylinder lock comprises at least one wireless data signal transmission interface for transmitting data and in particular data for programming the access codes for the access rights. This makes it possible to program the electronic control from the outside. The programming can for example be effected with the help of a portable device with a corresponding interface. This can obviously greatly simplify the programming process.

In principle, any type of interface may be used. It can be useful if the interface is an infrared interface or a transmitting/receiving unit for radio waves. Specifically, handheld computers and cell phone devices currently on the market are equipped with infrared interfaces so that these may easily be used for programming the lock cylinder.

It is favorable if the interface is enabled for activation or activated only if access rights have been detected. This has the advantage of ensuring that only an authorized person will make changes to the electronic control means.

It may be provided that the lock cylinder can be operated by using a key which works mechanically and bears the electronic access code, and that the interface is activated only when the key matches mechanically or matches both mechanically and electronically. In such electromechanical lock cylinders the arrangement is often choosen such that the key itself activates the electronic control means. Accordingly, it can be provided that this also activates the interface. As a whole, this guarantees that any change and, in particular, a programming for new access codes can in fact only be effected by authorized persons.

In principle, it is also possible with such lock cylinders that the programming is carried out using the key itself. The key has an antenna which interacts with the electronic control means and which can be used for such data transmission. To this end, the programming key can be retrofitted and for example can be connected to an active transmitting/receiving unit which enables data transmission to the electronic control means once the key has been inserted and access rights have been detected.

In principle, it is useful if the interface remains activated for a specific period of time only. This prevents unintentional and/or unauthorized changes of the electronic control means and programmed settings.

The electronic control means and/or the interface can e.g. be located in a knob, which usually has enough space for installation of the separate elements and assemblies. Furthermore, it is favorable to locate the sensor of the interface, i.e. the infrared sensor or the antenna of the transmitting/receiving unit, on the knob. The knob offers enough surface area for this, so that data can conveniently be transmitted from the outside.

Such a lock cylinder is also suitable for use in an access control system. It can be provided that upon an entry the interface transmits the entry to an appropriate control unit. This can be achieved by unidirectional data transmission so that it is impossible to program the lock cylinder via this signal transmission alone. Special keys with a different access code can be used to authorize a programming of the lock cylinder.

The control unit can comprise a transmission device which is located near the lock cylinder in question and is either wired to or standing in wireless connection with a central unit. With that, it is achieved that the electronic control means in the lock cylinder only have to send the signals via the interface over a short transmission distance. The transmitting power can be kept accordingly low whereby the energy demands of the usually off-the-line power supply is reduced.

Of course, it is also possible to program the lock cylinder using this transmission device or the control unit. In this case it can be provided that the transmission device is given additional protection, e.g. a coded keypad lock, to prevent unintentional or unauthorized programming of the lock cylinder.

In principle, it can be useful if a holding device is provided which can be fastened to the knob and/or to the door to keep the programming device or at least the part of it which holds the corresponding interface at a fixed distance to the interface on the lock cylinder. This has the advantage of ensuring perfect data transmission and that the person in question has both hands free to operate the programming device, e.g. a notebook. The holding device may be omitted if the lock cylinder is programmed using an inserted key.

In principle, it can be appropriate if at least the interface and preferably the electronic control means and/or the transmission device are located on the side of the lock cylinder opposite to the access side. This has the advantage of preventing, to the greatest possible extent, an intervention from outside when the door is closed. In particular, it is impossible to interfere in the wireless signal transmission route. Thus, the protection against manipulation is further increased.

In the following, the invention is explained by means of the schematic drawing the single figure of which shows a principle sketch of the electromechanical lock cylinder according to the invention.

The lock cylinder 11 shown in the drawing is mounted in the usual way in a box lock of a door 12. On its access side 13, the lock cylinder has a lock core with the usual pin locking and can be operated using a mechanical key 14 which also comprises an electronically detectable access code. A passive transponder system may for example be used for this purpose. On the side of the door 12 opposite to the access side 13, the lock cylinder 11 is provided with a knob 15 by means of which the lock may also be turned. The here necessary rotating-connection between lock catch and locking bar may be permanent or may only be created or enabled upon appropriate access rights.

Electronic control means 16 are provided within the knob which control means especially serve, on the one hand, to interpret the access code on the key 14 and, on the other hand, to create or enable the rotating-connection between key 14 and lock catch. The electronic control 16 means have an interface 17 which allows a wireless transmission of data signals to and from the electronic control means 16. This interface 17 can for example be an infrared interface or a transmitting/receiving unit for radio waves. Of course it is also possible to use both or similar types of signal transmission. The electronic control means 16 may be programmed with a programming device 18 by this interface 17. Especially, it is possible to change the authorized access codes for access rights in this way.

It is further possible that the electronic control means 16 are connected with a central unit 19 of an access control system via said interface 17. For instance, it may be provided that the interface 17 is programmable via an infrared sensor using the programming device 18 while it is in connection with said central unit 19 by means of a transmitting/receiving unit for radio waves. In particular, it may be provided that the connection to the central unit is unidirectional in order to prevent unintentional or unauthorized changes of the electronic control means 16. This makes it possible to monitor any access to the room closed off by the door 12. Provided, a code is needed to open the lock with the knob when leaving the room, it is also possible to detect the period of time a person spent in the room. These events can be recorded on a storage medium 22 or shown on a display device 23.

In the example shown in the drawing, the electronic control means 16 are not in direct connection with the central unit 19 of the access control system via the interface 17. As shown in the drawing, a transmission device 20 is provided which is in connection with the central unit 19 via a bus system 21. The transmission device is preferably located near the lock cylinder 11 and is for example protected with an additional electronic or mechanical lock. With that it is achieved that the signal transmission route between the interface 17 and transmission device 20, which has a corresponding interface, is kept short. The transmission power of the interface 17 can be kept accordingly low, thus reducing the energy demands on the usually off-the-line power supply of the lock cylinder.

As shown in the drawing, the interface 17, the electronic control means 16 and the transmission device 20 are all located on the side of the door 12 opposite to the access side 13. This reliably prevents intrusion from the outside. The central unit 19 can be located anywhere in the building and/or on the grounds. Of course, it is also possible that the transmission device is in connection with the central unit 19 via another transmitting/receiving unit. This is particularly useful if the transmission device is placed at a distant location on the grounds.

1. Electromechanical lock cylinder with integrated electronic control means (16) which upon electronically detectable access rights creates and/or enables a rotating-connection between a lock catch which operates a lock bolt and manually or motor operated actuation means (14), characterized in that the electronic control means of the cylinder lock comprise at least one wireless data signal transmission interface (17) for transmitting data and in particular data for programming the access codes for the access rights.

2. A lock cylinder according to claim 1, characterized in that the interface (17) is an infrared interface or a transmitting/receiving unit for radio waves.

3. A lock cylinder according to one of the claims 1 or 2, characterized in that the interface (17) is only activated or may only be activated after access rights have been detected.

4. A lock cylinder according to one of the claims 1 to 3, characterized in that the lock cylinder may be operated by a mechanical key (14) bearing the electronic access code, and that the interface is activated only when the key matches mechanically or matches both mechanically and electronically.

5. A lock cylinder according to claim 4, characterized in that the programming of lock is effected by the key itself.

6. A lock cylinder according to one of the claims 3 to 5, characterized in that the interface (17) remains activated for a determined time only.

7. A lock cylinder according to one of claims 1 to 6, characterized in that the electronic control means and/or the interface (17) are located in a knob (15).

8. A lock cylinder according to one of the claims 1 to 7, characterized in that the sensor of the interface, namely the infrared sensor or the antenna of the transmitting/receiving unit, is located on the knob (15).

9. A lock cylinder according to one of the claims 1 to 8, characterized in that upon an access has occurred the interface (17) transmits the access to an appropriate control unit (19, 20).

10. A lock cylinder according to claim 9, characterized in that the control unit comprises a transmission device (20) which is located near the lock cylinder in question (11) and is wired to or in wireless connection with a central unit (19).

11. A lock cylinder according to claim 10, characterized in that the programming can be effected by the transmission device or the control unit.

12. A lock cylinder according to one of the claims 1 to 11, characterized in that the programming can be effected by a portable device (18) with a corresponding interface.

13. A lock cylinder according to one of the claims 1 to 12, characterized in that a holding device is provided to be fastened to the knob and/or to the door in order to keep the programming device or at least the part of it holding the corresponding interface at a fixed distance to the interface of the lock cylinder.

14. A lock cylinder according to one of the claims 1 to 13, characterized in that at least the interface and preferably the electronic control means and/or the transmission device are located on the side of the lock cylinder (11) opposite to the access side (13).
